(19) United States
(12) Patent Application Publication
(10) Pub. No.: US 2026/0103013 A1
(43) Pub. Date: Apr. 16, 2026

(54) INK RIBBON CARTRIDGE

(71) Applicant: SEIKO EPSON CORPORATION, Tokyo (JP)

(72) Inventors: Kenji MOTAI, Matsumoto-shi (JP); Taishi SASAKI, Shiojiri-shi (JP); Hibiki AOYAMA, Matsumoto-shi (JP)

(73) Assignee: SEIKO EPSON CORPORATION, Tokyo (JP)

(21) Appl. No.: 19/359,233

(22) Filed: Oct. 15, 2025

(30) Foreign Application Priority Data
Oct. 16, 2024 (JP) 2024-180555
Mar. 24, 2025 (JP) 2025-048401

(51) Int. Cl. B41J 33/22; B41J 2/325; B41J 3/407; B41J 11/04; B41J 32/00; B41J 35/38

(52) U.S. Cl. CPC B41J 33/22; B41J 2/325; B41J 3/4075; B41J 11/04; B41J 32/00; B41J 35/38

(57) ABSTRACT

An ink ribbon cartridge to be mounted on a printing apparatus includes a cartridge case accommodating an ink ribbon and a gear train accommodated in the cartridge case. In a state where the ink ribbon cartridge is mounted on the printing apparatus, a rotation axis of a take-up roll on which the ink ribbon is taken up is different from a rotation axis of a take-up shaft, and the gear train is configured to transmit power of the take-up shaft to the take-up roll.

The present application is based on, and claims priority from JP Application Serial Number 2024-180555, filed Oct. 16, 2024, and JP Application Serial Number 2025-048401, filed Mar. 24, 2025, the disclosures of which are hereby incorporated by reference herein in their entirety.

### BACKGROUND

### 1. Technical Field

The present disclosure relates to an ink ribbon cartridge.

### 2. Related Art

For example, JP-A-2024-99367 discloses an ink ribbon cartridge in which an ink ribbon is accommodated in a cartridge case and a long tape, which is an example of a print medium, can be introduced from the outside of the cartridge case to the inside of the cartridge case. In a state in which such an ink ribbon cartridge is mounted on a printing apparatus, the tape and the ink ribbon are transported while being pinched between a head and a platen roller, and printing is performed on the tape by heating the ink ribbon.

However, in such an ink ribbon cartridge, although it is possible to introduce the print medium from the outside of the cartridge case to the inside of the cartridge case, it is desired to increase the amount of the ink ribbon accommodated in the cartridge case.

### SUMMARY

An ink ribbon cartridge according to an aspect of the present disclosure is to be mounted on a printing apparatus having a take-up shaft for taking up an ink ribbon. The ink ribbon cartridge includes a cartridge case accommodating the ink ribbon and a gear train accommodated in the cartridge case. In a state where the ink ribbon cartridge is mounted on the printing apparatus, a rotation axis of a take-up roll on which the ink ribbon is taken up is different from a rotation axis of the take-up shaft, and the gear train is configured to transmit power of the take-up shaft to the take-up roll.

### BRIEF DESCRIPTION OF THE DRAWINGS

FIG. 1 is a perspective view illustrating a printing apparatus and an ink ribbon cartridge according to a first embodiment.

FIG. 2 is a top view illustrating the printing apparatus according to the first embodiment.

FIG. 3 is a top view illustrating the ink ribbon cartridge according to the first embodiment.

FIG. 4 is a perspective view illustrating the ink ribbon cartridge according to the first embodiment.

FIG. 5 is a top view illustrating the printing apparatus and the ink ribbon cartridge according to the first embodiment.

FIG. 6 is a perspective view illustrating the printing apparatus and the ink ribbon cartridge according to the first embodiment.

FIG. 7 is a top view illustrating a printing apparatus and an ink ribbon cartridge according to a second embodiment.

FIG. 8 is a top view illustrating a printing apparatus and an ink ribbon cartridge according to a third embodiment.

### DESCRIPTION OF EMBODIMENTS

### First Embodiment

Hereinafter, an embodiment of an ink ribbon cartridge which can be mounted on a printing apparatus will be described with reference to the drawings. In the following description, in a case where the ink ribbon cartridge is mounted on the printing apparatus in a state where the printing apparatus is installed on a horizontal surface, an axis intersecting the horizontal surface is referred to as a Z-axis, an axis intersecting the Z-axis is referred to as an X-axis, and an axis intersecting the X-axis and the Z-axis is referred to as a Y-axis. One direction along the X-axis is referred to as a first widthwise direction X1, and the other direction along the X-axis is referred to as a second widthwise direction X2. One direction along the Y-axis is referred to as a front side Y1, and the other direction along the Y-axis is referred to as a rear side Y2. An upward direction along the Z-axis is referred to as an upper side Z1, and a downward direction along the Z-axis is referred to as a lower side Z2. The first widthwise direction X1 corresponds to an example of a first direction, and the front side Y1 corresponds to an example of a second direction. A view from the upper side Z1 is simply referred to as a top view.

### Configuration of Printing Apparatus 100

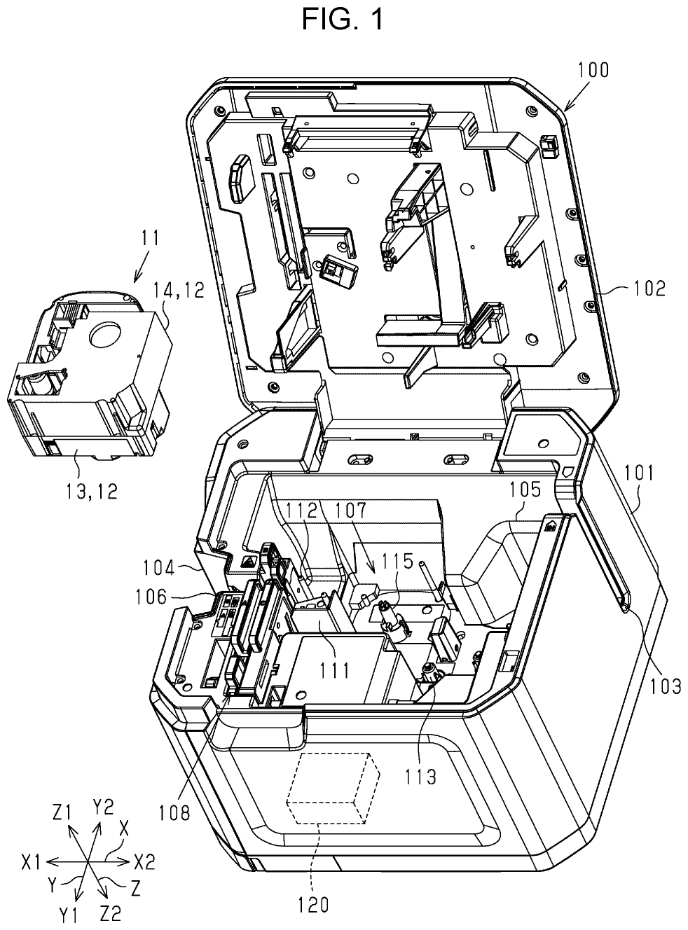

As illustrated in FIG. 1, a printing apparatus 100 is configured to perform printing on a print medium. An ink ribbon cartridge 11 can be mounted on the printing apparatus 100. The printing apparatus 100 is configured to perform printing on a print medium in a state where the ink ribbon cartridge 11 is mounted. The printing apparatus 100 may be configured to perform printing on a print medium which can be introduced from the outside of the printing apparatus 100 and the ink ribbon cartridge 11 in a state where the ink ribbon cartridge 11 is mounted. The print medium may, for example, be a tubular print medium. The tubular print medium may, for example, be a tube.

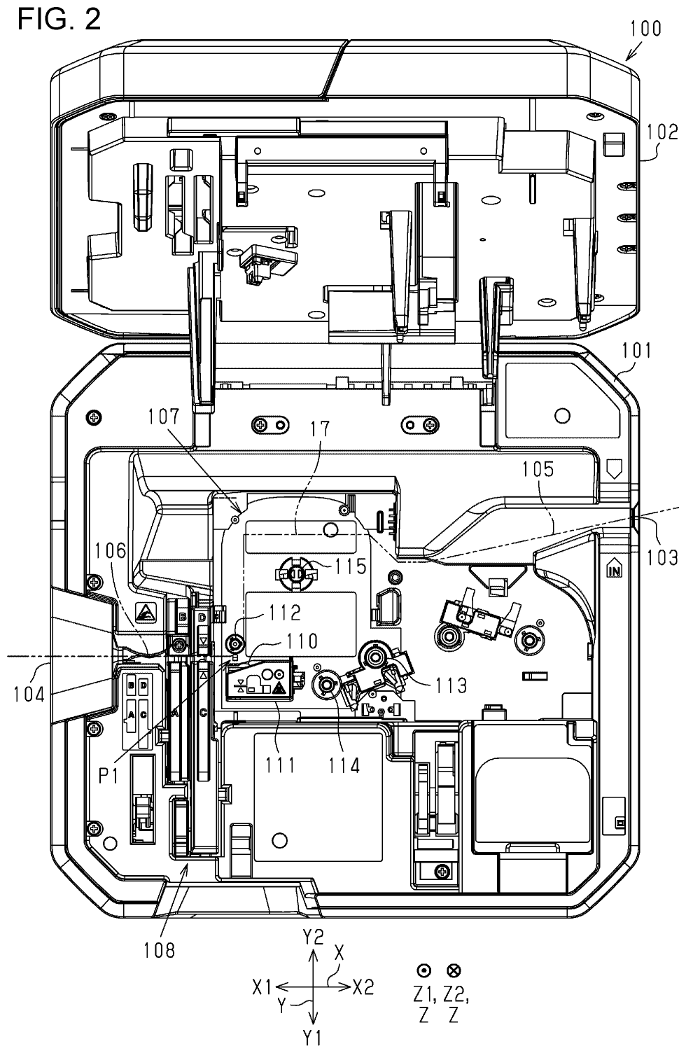

As illustrated in FIG. 2, the printing apparatus 100 includes an apparatus case 101 and an apparatus cover 102. The apparatus case 101 is configured to accommodate various members of the printing apparatus 100. The apparatus case 101 may have a substantially rectangular parallelepiped shape.

The apparatus cover 102 can be opened and closed with respect to the apparatus case 101. The apparatus cover 102 may be rotatably attached to an end portion on the rear side Y2 of the apparatus case 101. The apparatus cover 102 covers the apparatus case 101 from the upper side Z1. The apparatus cover 102 covers the inside of the apparatus case 101. The apparatus cover 102 covers the inside of the apparatus case 101 in a state where the ink ribbon cartridge 11 is mounted.

The apparatus case 101 includes an apparatus side introduction port 103, an apparatus side discharge port 104, an apparatus side introduction path 105, an apparatus side discharge path 106, and a cartridge mounting portion 107. That is, the printing apparatus 100 includes the apparatus side introduction port 103, the apparatus side discharge port 104, the apparatus side introduction path 105, the apparatus side discharge path 106, and the cartridge mounting portion 107.

The apparatus side introduction port 103 may be provided in the second widthwise direction X2 of the apparatus case 101. The apparatus side introduction port 103 may have a shape extending along the Z-axis. The apparatus side introduction port 103 may be a cutout that opens to the upper side Z1. The apparatus side introduction port 103 is a portion for introducing the print medium from the outside of the printing apparatus 100 to the inside of the printing apparatus 100.

The apparatus side discharge port 104 may be provided in the first widthwise direction X1 of the apparatus case 101. The apparatus side discharge port 104 may have a shape extending along the Z-axis. The apparatus side discharge port 104 may be a cutout that opens to the upper side Z1. The apparatus side discharge port 104 is a portion for discharging the print medium from the inside of the printing apparatus 100 to the outside of the printing apparatus 100.

The apparatus side introduction path 105 is provided between the apparatus side introduction port 103 and the cartridge mounting portion 107. The apparatus side introduction path 105 is a path for transporting the print medium introduced from the apparatus side introduction port 103 to the cartridge mounting portion 107 between the apparatus side introduction port 103 and the cartridge mounting portion 107. The apparatus side introduction path 105 may be a recessed portion that opens to the upper side Z1.

The apparatus side discharge path 106 is provided between the cartridge mounting portion 107 and the apparatus side discharge port 104. The apparatus side discharge path 106 is a path for discharging the print medium transported from the cartridge mounting portion 107 from the apparatus side discharge port 104 between the cartridge mounting portion 107 and the apparatus side discharge port 104. The apparatus side discharge path 106 may be a recessed portion that opens to the upper side Z1.

The cartridge mounting portion 107 is a recessed portion that opens to the upper side Z1. The cartridge mounting portion 107 is connected to the apparatus side introduction path 105 in the second widthwise direction X2. The cartridge mounting portion 107 is connected to the apparatus side discharge path 106 in the first widthwise direction X1.

The ink ribbon cartridge 11 can be attached to and detached from the cartridge mounting portion 107 from the upper side Z1. The cartridge mounting portion 107 can accommodate the mounted ink ribbon cartridge 11.

An ink ribbon cartridge 11 in which a print medium has been introduced can be attached to and detached from the cartridge mounting portion 107. In such a case, the print medium introduced into the ink ribbon cartridge 11 can be inserted into the apparatus side introduction port 103 and the apparatus side introduction path 105 from the upper side Z1.

The printing apparatus 100 includes a head 110 and a head cover 111. The head 110 and the head cover 111 are provided in the apparatus case 101. The head 110 and the head cover 111 are provided in the cartridge mounting portion 107.

The head 110 is configured to perform printing on a print medium. The head 110 may be a thermal head that performs printing on a print medium using a heating element. The head 110 is provided at a printing position P1. The printing position P1 is a position at which printing is performed on the print medium by the head 110. The printing position P1 is a position along a medium transport path 17 described further below. The head cover 111 partially covers the head 110.

The printing apparatus 100 includes a platen shaft 112. The platen shaft 112 is provided in the apparatus case 101. The platen shaft 112 is provided in the cartridge mounting portion 107. The platen shaft 112 is provided so as to protrude from the bottom surface of the cartridge mounting portion 107 toward the upper side Z1. The platen shaft 112 is a shaft for transmitting power to a platen roller 22 of the ink ribbon cartridge 11 described below.

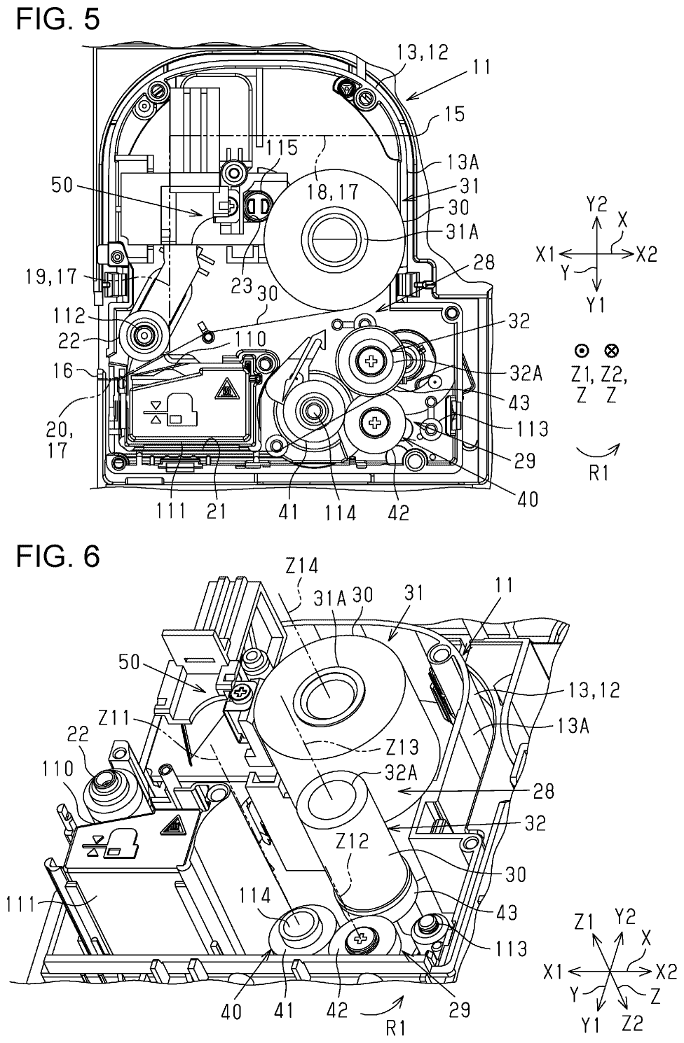

The printing apparatus 100 includes a pay-out shaft 113. The pay-out shaft 113 is provided in the apparatus case 101. The pay-out shaft 113 is provided in the cartridge mounting portion 107. The pay-out shaft 113 is provided so as to protrude from the bottom surface of the cartridge mounting portion 107 toward the upper side Z1. The pay-out shaft 113 is a shaft for paying out an ink ribbon 30 illustrated in FIG. 5 accommodated in the ink ribbon cartridge 11. That is, the pay-out shaft 113 is a shaft that pays out the ink ribbon 30.

The printing apparatus 100 includes a take-up shaft 114. The take-up shaft 114 is provided in the apparatus case 101. The take-up shaft 114 is provided in the cartridge mounting portion 107. The take-up shaft 114 is provided so as to protrude from the bottom surface of the cartridge mounting portion 107 toward the upper side Z1. The take-up shaft 114 is a shaft that transmits power for taking up the ink ribbon 30 accommodated in the ink ribbon cartridge 11. That is, the take-up shaft 114 is a shaft that takes up the ink ribbon 30.

The printing apparatus 100 includes a protruding portion 115. The protruding portion 115 is provided in the apparatus case 101. The protruding portion 115 is provided in the cartridge mounting portion 107. The protruding portion 115 is provided so as to protrude toward the upper side Z1. The protruding portion 115 may be provided so as to protrude from the bottom surface of the cartridge mounting portion 107 toward the upper side Z1.

When the apparatus cover 102 is closed in a state where the ink ribbon cartridge 11 is mounted on the cartridge mounting portion 107, the head 110 is moved toward the platen roller 22 by a head moving mechanism (not shown). As a result, the print medium and the ink ribbon 30 are pinched between the head 110 and the platen roller 22.

When the platen shaft 112 and the take-up shaft 114 rotate in this state, the print medium and the ink ribbon 30 are fed. At this time, the head 110 generates heat based on print data, so that the ink of the ink ribbon 30 is transferred to the print medium. Thus, printing is performed on the print medium.

In the present embodiment, the ink ribbon cartridge 11 is configured to pay out the ink ribbon 30 by taking up the ink ribbon 30 in response to the power from the take-up shaft 114 without receiving the power from the pay-out shaft 113, but is not limited thereto.

The printing apparatus 100 may include a cutter mechanism 108. The cutter mechanism 108 is provided in the apparatus case 101. The cutter mechanism 108 is provided downstream of the printing position P1 in a transport direction in which the print medium is transported. The cutter mechanism 108 may be provided in the apparatus side discharge path 106. The cutter mechanism 108 is configured to cut the print medium after printing.

As shown in FIG. 1, the printing apparatus 100 includes a control unit 120. The control unit 120 integrally controls the printing apparatus 100. The control unit 120 controls various operations executed by the printing apparatus 100. The control unit 120 may be configured as a circuit including α: one or more processors that execute various processes in accordance with a computer program, β: one or more dedicated hardware circuits that execute at least some of the various processes, or γ: a combination thereof. The hardware circuit is, for example, an application-specific integrated circuit. The processor includes a CPU and memory, such as RAM and ROM, and the memory stores program codes or instructions configured to cause the CPU to perform processes. The memory, that is, a computer-readable medium, includes any readable medium that can be accessed by a general-purpose or dedicated computer.

The control unit 120 can control the head 110. The control unit 120 can control a driving unit (not shown) that drives each of the platen shaft 112, the pay-out shaft 113, the take-up shaft 114, and the protruding portion 115. The control unit 120 can control the cutter mechanism 108.

In the present embodiment, the printing apparatus 100 may be configured such that both the ink ribbon cartridge 11 and a tape cartridge (not shown) can be used.

In this way, the printing apparatus 100 may be configured such that the ink ribbon cartridge 11 and the tape cartridge (not shown) can be selectively mounted on the cartridge mounting portion 107.

The tape cartridge is a cartridge that accommodates a print tape roll. The print tape roll is a rolled tape serving as a print medium. The protruding portion 115 may be configured to be inserted into the rotation center of the print tape roll when the tape cartridge (not shown) is mounted on the cartridge mounting portion 107. When the tape cartridge (not shown) is mounted on the cartridge mounting portion 107, the protruding portion 115 may transmit a driving force for rotating the print tape roll.

### Configuration of Ink Ribbon Cartridge 11

The ink ribbon cartridge 11 can be mounted on the printing apparatus 100. The ink ribbon cartridge 11 can be mounted on the cartridge mounting portion 107. The ink ribbon cartridge 11 accommodates the ink ribbon 30. The ink ribbon cartridge 11 may be configured to perform printing on a print medium that can be introduced from the outside of the ink ribbon cartridge 11.

The ink ribbon cartridge 11 includes a cartridge case 12. The cartridge case 12 is the exterior of the ink ribbon cartridge 11. The cartridge case 12 accommodates various components of the ink ribbon cartridge 11. The cartridge case 12 accommodates the ink ribbon 30.

The cartridge case 12 includes a first case 13 and a second case 14. When the ink ribbon cartridge 11 is mounted on the printing apparatus 100, the second case 14 is located on the upper side Z1 of the first case 13. The second case 14 is configured to cover the first case 13 from the upper side Z1.

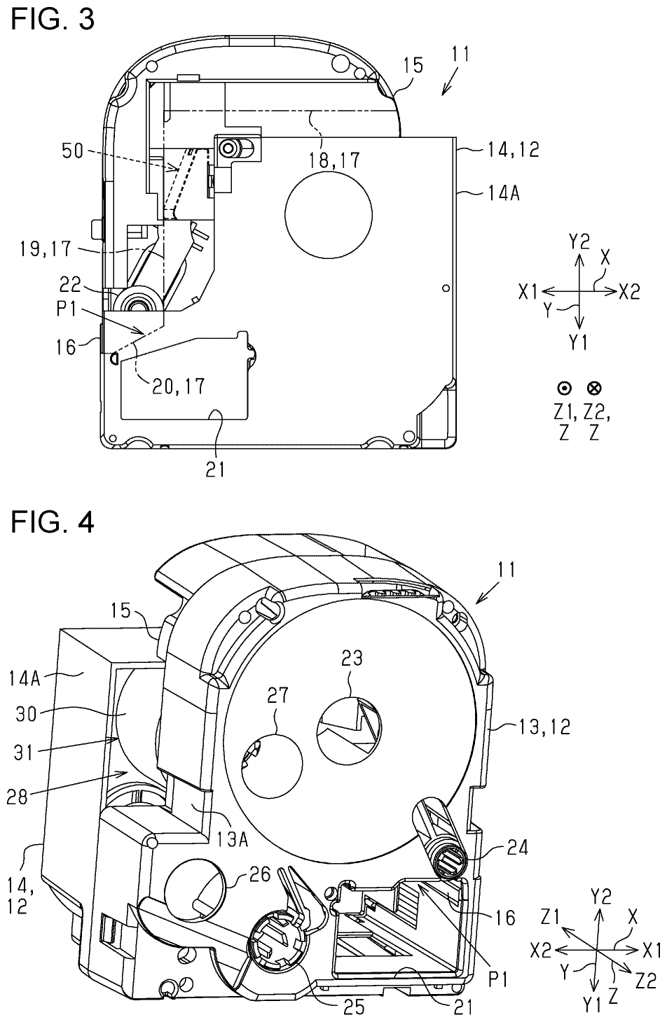

As illustrated in FIG. 3, the cartridge case 12 includes an introduction port 15 and a discharge port 16. The introduction port 15 may be provided on the second widthwise direction X2 side of the cartridge case 12. The introduction port 15 may have a shape extending along the Z-axis. The introduction port 15 may be a cutout that opens to the upper side Z1. The introduction port 15 is provided in the second case 14, but may be provided in the first case 13, or may be provided across the first case 13 and the second case 14. The introduction port 15 is a portion for introducing a print medium from the outside of the cartridge case 12 to the inside of the cartridge case 12.

The discharge port 16 may be provided on the first widthwise direction X1 side of the cartridge case 12. The discharge port 16 may have a shape extending along the Z-axis. The discharge port 16 may be a cutout that opens to the upper side Z1. The discharge port 16 is provided in the second case 14, but may be provided in the first case 13, or may be provided across the first case 13 and the second case 14. The discharge port 16 is a portion for discharging the print medium from the inside of the cartridge case 12.

The cartridge case 12 includes the medium transport path 17. The medium transport path 17 is provided in the second case 14, but may be provided in the first case 13, or may be provided across the first case 13 and the second case 14.

The medium transport path 17 is connected to the introduction port 15 and the discharge port 16 in the cartridge case 12. The medium transport path 17 is a path along which a print medium is transported. The medium transport path 17 is a path for transporting the print medium introduced to the inside of the cartridge case 12 through the introduction port 15.

The medium transport path 17 is a path that connects at least the introduction port 15 and the printing position P1. The medium transport path 17 is a path along which the print medium introduced from the introduction port 15 is transported to the printing position P1. The medium transport path 17 is a path that connects the printing position P1 and the discharge port 16. The medium transport path 17 is a path for transporting the print medium printed at the printing position P1 so that the print medium is discharged from the discharge port 16.

The medium transport path 17 includes a first transport path 18, a second transport path 19, and a discharge path 20. The first transport path 18 is connected to the introduction port 15. The first transport path 18 extends along the X-axis. The first transport path 18 extends from the introduction port 15 in the first widthwise direction X1. Thus, in the first transport path 18, the transport direction in which the print medium is transported is the first widthwise direction X1.

The second transport path 19 is connected to the first transport path 18. The second transport path 19 includes a path extending along the Y-axis. The second transport path 19 includes a path extending from the first transport path 18 to the front side Y1. The printing position P1 is a position along the second transport path 19. That is, the second transport path 19 is a path including the printing position P1. Thus, in the second transport path 19, the transport direction in which the print medium is transported is the front side Y1.

In the present embodiment, the second transport path 19 includes a path that extends so as to be inclined toward the front side Y1 and the first widthwise direction X1, but it need not include a path that extends so as to be inclined toward the front side Y1 and the first widthwise direction X1.

The discharge path 20 is connected to the second transport path 19. The discharge path 20 is connected to the discharge port 16. The discharge path 20 extends along the X-axis. The discharge path 20 extends in the first widthwise direction X1 toward the discharge port 16. Thus, in the discharge path 20, the transport direction in which the print medium is transported is the first widthwise direction X1.

As illustrated in FIGS. 3 and 4, the cartridge case 12 includes a head insertion hole 21. That is, the ink ribbon cartridge 11 includes the head insertion hole 21. The head insertion hole 21 is provided so as to extend through the cartridge case 12 along the Z-axis. Specifically, the head insertion hole 21 is provided in the first case 13 and the second case 14. The head insertion hole 21 is provided so as to extend through the first case 13 and the second case 14.

In a state where the ink ribbon cartridge 11 is mounted on the cartridge mounting portion 107, the head 110 and the head cover 111 are inserted into the head insertion hole 21 toward the upper side Z1. That is, the head 110 can be inserted into the head insertion hole 21 at the printing position P1. Thus, the upper side Z1 corresponds to an example of an insertion direction, and the lower side Z2 corresponds to an example of the direction opposite to the insertion direction.

As illustrated in FIG. 3, the ink ribbon cartridge 11 may include the platen roller 22. The platen roller 22 is provided in the cartridge case 12. The platen roller 22 is configured to extend along the Z-axis. The platen roller 22 is provided in the second case 14 along the Z-axis, but may be provided so as to straddle the first case 13 and the second case 14.

In a state where the ink ribbon cartridge 11 is mounted on the cartridge mounting portion 107, the platen roller 22 is provided at a position facing the head 110. In a state where the ink ribbon cartridge 11 is mounted on the cartridge mounting portion 107, the platen roller 22 is configured to pinch the print medium and the ink ribbon 30 between the platen roller 22 and the head 110 at the printing position P1.

In a state where the ink ribbon cartridge 11 is mounted on the cartridge mounting portion 107, power is transmitted to the platen roller 22 from the platen shaft 112. The print medium and the ink ribbon 30 are transported along the medium transport path 17 by the rotation of the platen roller 22 while being pinched between the platen roller 22 and the head 110.

In the present embodiment, the print medium has a size equal to or less than half of the length of the ink ribbon cartridge 11 along the Z-axis, but is not limited thereto. The print medium is transported along the medium transport path 17 provided in the second case 14 inside the ink ribbon cartridge 11, but is not limited thereto.

The ink ribbon cartridge 11 includes a restricting portion 50. The restricting portion 50 may be provided at a position along the second transport path 19. The restricting portion 50 may be provided at a position upstream of the printing position P1 along the second transport path 19. The restricting portion 50 may be provided at a position upstream of the head insertion hole 21 along the second transport path 19. The restricting portion 50 may be provided in the second case 14.

The restricting portion 50 is configured to restrict the movement of the print medium in a restriction direction. The restriction direction may include a component in the second widthwise direction X2 and a component toward the lower side Z2 in the second transport path 19.

As illustrated in FIG. 4, the first case 13 may include an insertion hole 23. That is, the insertion hole 23 may be provided in the cartridge case 12. The insertion hole 23 is a hole that extends through the first case 13 along the Z-axis. The insertion hole 23 is a hole into which the protruding portion 115 can be inserted. When the ink ribbon cartridge 11 is mounted on the cartridge mounting portion 107, the protruding portion 115 is inserted into the insertion hole 23.

The first case 13 includes a platen shaft insertion hole 24. That is, the platen shaft insertion hole 24 is provided in the cartridge case 12. The platen shaft insertion hole 24 is a hole that extends through the first case 13 along the Z-axis. The platen shaft insertion hole 24 is a hole into which the platen shaft 112 can be inserted. When the ink ribbon cartridge 11 is mounted on the cartridge mounting portion 107, the platen shaft 112 is inserted into the platen shaft insertion hole 24. Accordingly, in a state where the platen shaft 112 and the platen roller 22 are engaged with each other, the power from the platen shaft 112 is transmitted to the platen roller 22.

The first case 13 includes a take-up shaft insertion hole 25. That is, the take-up shaft insertion hole 25 is provided in the cartridge case 12. The take-up shaft insertion hole 25 is a hole that extends through the first case 13 along the Z-axis. The take-up shaft insertion hole 25 is a hole into which the take-up shaft 114 can be inserted. When the ink ribbon cartridge 11 is mounted on the cartridge mounting portion 107, the take-up shaft 114 is inserted into the take-up shaft insertion hole 25.

The first case 13 may include a first pay-out shaft insertion hole 26. That is, the cartridge case 12 may be provided with the first pay-out shaft insertion hole 26. The first pay-out shaft insertion hole 26 is a hole that extends through the first case 13 along the Z-axis. The first pay-out shaft insertion hole 26 is a hole into which the pay-out shaft 113 can be inserted. When the ink ribbon cartridge 11 is mounted on the cartridge mounting portion 107, the pay-out shaft 113 is inserted into the first pay-out shaft insertion hole 26.

The first case 13 may include a second pay-out shaft insertion hole 27. That is, the cartridge case 12 may be provided with the second pay-out shaft insertion hole 27. The second pay-out shaft insertion hole 27 is a hole that extends through the first case 13 along the Z-axis. The second pay-out shaft insertion hole 27 may be a hole into which a pay-out shaft of an apparatus different from the printing apparatus 100 can be inserted. In a case where the ink ribbon cartridge 11 is mounted on an apparatus different from the printing apparatus 100, a pay-out shaft of the apparatus different from the printing apparatus 100 may be inserted into the second pay-out shaft insertion hole 27.

As illustrated in FIG. 5, the cartridge case 12 includes an ink ribbon accommodating area 28. The ink ribbon accommodating area 28 is provided on the second case 14 side along the Z-axis. The ink ribbon accommodating area 28 is provided in the second case 14 along the Z-axis, but may be provided so as to straddle the second case 14 and the first case 13.

The ink ribbon accommodating area 28 is an area in which the ink ribbon 30 can be accommodated in the cartridge case 12. The ink ribbon accommodating area 28 is an area that accommodates a pay-out roll 31. The ink ribbon accommodating area 28 is an area that accommodates a take-up roll 32.

The pay-out roll 31 is a roll body around which the ink ribbon 30 to be fed to the printing position P1 is wound. The pay-out roll 31 includes a pay-out core 31A. The pay-out roll 31 may include the ink ribbon 30 wound around the pay-out core 31A.

The take-up roll 32 is a roll body on which the ink ribbon 30 transported from the printing position P1 is taken up. The take-up roll 32 includes a take-up core 32A.

The take-up roll 32 may include the ink ribbon 30 taken up on the take-up core 32A.

The ink ribbon cartridge 11 includes a gear train accommodating area 29 and a gear train 40. The gear train accommodating area 29 is provided in the cartridge case 12. The gear train accommodating area 29 is an area that accommodates the gear train 40. That is, the gear train 40 is accommodated in the cartridge case 12.

The gear train accommodating area 29 is provided on the first case 13 side along the Z-axis. The gear train accommodating area 29 is provided in the first case 13 along the Z-axis, but may be provided so as to straddle the first case 13 and the second case 14. The gear train accommodating area 29 is provided so as to overlap the ink ribbon accommodating area 28 in a top view.

As illustrated in FIGS. 5 and 6, the gear train 40 is configured to transmit the power of the take-up shaft 114 inserted into the take-up shaft insertion hole 25 to the take-up roll 32 when the ink ribbon cartridge 11 is mounted on the cartridge mounting portion 107.

The gear train 40 may be configured to rotate the take-up roll 32 in a first circumferential direction R1 when the take-up shaft 114 rotates in the first circumferential direction R1. The gear train 40 may be configured such that the ratio between the rotation speed of the take-up shaft 114 and the rotation speed of the take-up roll 32 is 1:1.

The gear train 40 may include a first gear 41, a second gear 42, and a third gear 43. The rotation axis of the first gear 41 is a first rotation axis Z11. The first rotation axis Z11 is along the Z-axis. When the ink ribbon cartridge 11 is mounted on the cartridge mounting portion 107, the first gear 41 is coaxial with the take-up shaft 114. That is, when the ink ribbon cartridge 11 is mounted on the cartridge mounting portion 107, the first rotation axis Z11 is the same as the rotation axis of the take-up shaft 114. Thus, the first rotation axis Z11 is the rotation axis of the take-up shaft 114, and is also the rotation axis of the first gear 41. The power from the take-up shaft 114 is transmitted to the first gear 41.

The rotation axis of the second gear 42 is a second rotation axis Z12. The second rotation axis Z12 is along the Z-axis. The second rotation axis Z12 is provided so as to be parallel to the first rotation axis Z11, and is different from the first rotation axis Z11 in position in the XY plane, that is, in the bottom surface of the first case 13 intersecting the Z-axis.

The second gear 42 is provided so as to mesh with the first gear 41. The second gear 42 is provided so as to mesh with the third gear 43. In this way, the second gear 42 is configured to transmit the power of the first gear 41 to the third gear 43.

The rotation axis of the third gear 43 is a third rotation axis Z13. The third rotation axis Z13 is along the Z-axis. The third rotation axis Z13 is provided so as to be parallel to the first rotation axis Z11, and is coaxial with the take-up roll 32. That is, the third rotation axis Z13 is the same as the rotation axis of the take-up roll 32. The third rotation axis Z13 is different from the first rotation axis Z11 in position in the XY plane, that is, in the bottom surface of the first case 13 intersecting the Z-axis. Thus, the third rotation axis Z13 is the rotation axis of the third gear 43, and is also the rotation axis of the take-up roll 32. The power from the second gear 42 is transmitted to the third gear 43. That is, the third gear 43 transmits the power from the take-up shaft 114 to the take-up roll 32.

As described above, in a state where the ink ribbon cartridge 11 is mounted on the cartridge mounting portion 107, the rotation axis of the take-up roll 32 is provided so as to be parallel to the rotation axis of the take-up shaft 114 and is different from the rotation axis of the take-up shaft 114. The lower side Z2 corresponds to an example of a first axial direction, and the upper side Z1 corresponds to an example of the direction opposite to the first axial direction.

In particular, the third rotation axis Z13 is located farther in the second widthwise direction X2 than is the first rotation axis Z11. The third rotation axis Z13 is located farther away from the second transport path 19 than is the first rotation axis Z11. The third rotation axis Z13 is separated from a fourth rotation axis Z14 by a predetermined distance. The fourth rotation axis Z14 is the rotation axis of the pay-out roll 31.

The predetermined distance is a distance corresponding to the amount of the ink ribbon 30 accommodated. The predetermined distance may be greater than the sum of the radius of the pay-out roll 31 and the radius of the take-up roll 32. The predetermined distance may be equal to or greater than the radius of the unused pay-out roll 31 around which the ink ribbon 30 is wound without being fed. The radius of the unused pay-out roll 31 around which the ink ribbon 30 is wound without being fed is the maximum radius of the pay-out roll 31. The predetermined distance may be equal to or greater than the radius of the take-up roll 32 assumed when the take-up of the entire ink ribbon 30 is completed. The radius of the take-up roll 32 assumed when the take-up of the entire ink ribbon 30 is completed is the maximum radius of the take-up roll 32.

The pay-out roll 31 is disposed in an area surrounded by the first transport path 18, the second transport path 19, and the gear train accommodating area 29 in the ink ribbon accommodating area 28 in a top view. The pay-out roll 31 is disposed in an area between the insertion hole 23 and the gear train accommodating area 29 in a top view. The insertion hole 23 is provided in an area surrounded by the first transport path 18, the second transport path 19, and the ink ribbon accommodating area 28.

As illustrated in FIG. 4, the first case 13 includes a sidewall 13A in the second widthwise direction X2. The second case 14 includes a sidewall 14A in the second widthwise direction X2. In the present embodiment, the sidewall 14A is located farther in the second widthwise direction X2 than is the sidewall 13A in a top view.

Thus, the second case 14 is configured to protrude from the sidewall 13A of the first case 13 in a top view. In a top view, the ink ribbon accommodating area 28 may include an area that protrudes outward from the sidewall 13A of the first case 13 in the second widthwise direction X2.

### Operation and Effects of First Embodiment

The operation and effects of the first embodiment will be described.
(1) In a state where the ink ribbon cartridge 11 is mounted on the printing apparatus 100, the rotation axis of the take-up roll 32 on which the ink ribbon 30 is taken up is parallel to the rotation axis of the take-up shaft 114 and is different from the rotation axis of the take-up shaft 114. The gear train 40 is configured to transmit the power of the take-up shaft 114 to the take-up roll 32. With this configuration, since the power of the take-up shaft 114 is transmitted to the take-up roll 32 by the gear train 40, the rotation axis of the take-up roll 32 can be made different from the rotation axis of the take-up shaft 114. As a result, it is possible to adjust the arrangement of the area in which the take-up roll 32 is accommodated inside the cartridge case 12. Therefore, the amount of the ink ribbon 30 accommodated in the cartridge case 12 can be increased.
(2) The cartridge case 12 includes the first case 13 and the second case 14 located on the upper side Z1 of the first case 13. The first case 13 includes the gear train accommodating area 29 that accommodates the gear train 40. The second case 14 includes the introduction port 15 through which a print medium is introduced into the cartridge case 12, the medium transport path 17 along which the print medium is transported, and the ink ribbon accommodating area 28 that accommodates the pay-out roll 31 and the take-up roll 32. With this configuration, it is possible to provide the gear train accommodating area 29 that accommodates the gear train 40 in the first case 13, and to provide the introduction port 15, the medium transport path 17, and the ink ribbon accommodating area 28 in the second case 14. As a result, it is possible to provide the gear train accommodating area 29 in the first case 13 so as not to interfere with the introduction port 15, the medium transport path 17, or the ink ribbon accommodating area 28 in the second case 14. Therefore, the amount of the ink ribbon 30 accommodated in the cartridge case 12 can be increased.
(3) The gear train 40 includes the first gear 41 coaxial with the take-up shaft 114 in a top view, the third gear 43 having a rotation axis which is the same as the rotation axis of the take-up roll 32 in a top view, and the second gear 42 which transmits the power of the first gear 41 to the third gear 43. The rotation axis of the third gear 43 is separated from the rotation axis of the pay-out roll 31 by a predetermined distance. With this configuration, the power of the take-up shaft 114 can be transmitted to the take-up roll 32 by using the first gear 41, the second gear 42, and the third gear 43. In addition, the rotation axis of the take-up roll 32, which is coaxial with the third gear 43, can be separated from the rotation axis of the pay-out roll 31 by a predetermined distance. As a result, it is possible to accommodate an amount of the ink ribbon 30 in consideration of the predetermined distance. Therefore, the amount of the ink ribbon 30 accommodated in the cartridge case 12 can be increased.
(4) The gear train 40 rotates the take-up roll 32 in the first circumferential direction R1 when the take-up shaft 114 rotates in the first circumferential direction R1. With this configuration, it is possible to rotate the take-up shaft 114 and the take-up roll 32 in the same first circumferential direction R1. As a result, it is possible to suppress a decrease in printing quality. In addition, the configuration of the printing apparatus 100 need not be changed.
(5) The gear train 40 is configured such that the ratio between the rotation speed of the take-up shaft 114 and the rotation speed of the take-up roll 32 is 1:1. With this configuration, the rotation speed of the take-up shaft 114 and the rotation speed of the take-up roll 32 can be set to the same ratio. As a result, it is possible to suppress a decrease in printing quality. In addition, the configuration of the printing apparatus 100 need not be changed.
(6) The medium transport path 17 includes the first transport path 18 extending from the introduction port 15 in the first widthwise direction X1, and a second transport path 19 connected to the first transport path 18 and extending toward the front side Y1. In a top view, the pay-out roll 31 is disposed in an area surrounded by the first transport path 18, the second transport path 19, and the gear train accommodating area 29 in the ink ribbon accommodating area 28. With this configuration, it is possible to provide the ink ribbon accommodating area 28 such that the pay-out roll 31 does not interfere with the first transport path 18, the second transport path 19, or the gear train accommodating area 29. Therefore, the amount of the ink ribbon 30 accommodated in the cartridge case 12 can be increased.
(7) The cartridge case 12 is provided with the insertion hole 23 through which the protruding portion 115 is inserted when the ink ribbon cartridge 11 is mounted on the cartridge mounting portion 107. When the ink ribbon cartridge 11 is mounted on the cartridge mounting portion 107, the pay-out roll 31 is disposed in an area between the insertion hole 23 and the gear train accommodating area 29 in a top view. With this configuration, in a top view, the pay-out roll 31 is disposed in an area between the insertion hole 23 into which the protruding portion 115 is inserted and the gear train accommodating area 29. As a result, it is possible to provide the ink ribbon accommodating area 28 such that the pay-out roll 31 does not interfere with the protruding portion 115 inserted into the insertion hole 23 or the gear train accommodating area 29. Therefore, the amount of the ink ribbon 30 accommodated in the cartridge case 12 can be increased. In addition, the ink ribbon cartridge 11 and a tape cartridge (not shown) can be selectively mounted on the printing apparatus 100.
(8) The second case 14 is configured to protrude outward from the sidewall 13A of the first case 13 in a top view. The ink ribbon accommodating area 28 includes an area that protrudes outward from the sidewall 13A of the first case 13 in a top view. With this configuration, the second case 14 in which the ink ribbon accommodating area 28 is provided can be provided so as to protrude outward from the sidewall 13A of the first case 13 in which the gear train accommodating area 29 is provided. Therefore, it is possible to increase the amount of the ink ribbon 30 accommodated in the cartridge case 12 while suppressing an increase in the size of the first case 13.

### Second Embodiment

Next, a second embodiment will be described. In the following description, redundant description of the same configuration as that of the above-described embodiment will be omitted or simplified, and a configuration different from that of the above-described embodiment will be described.

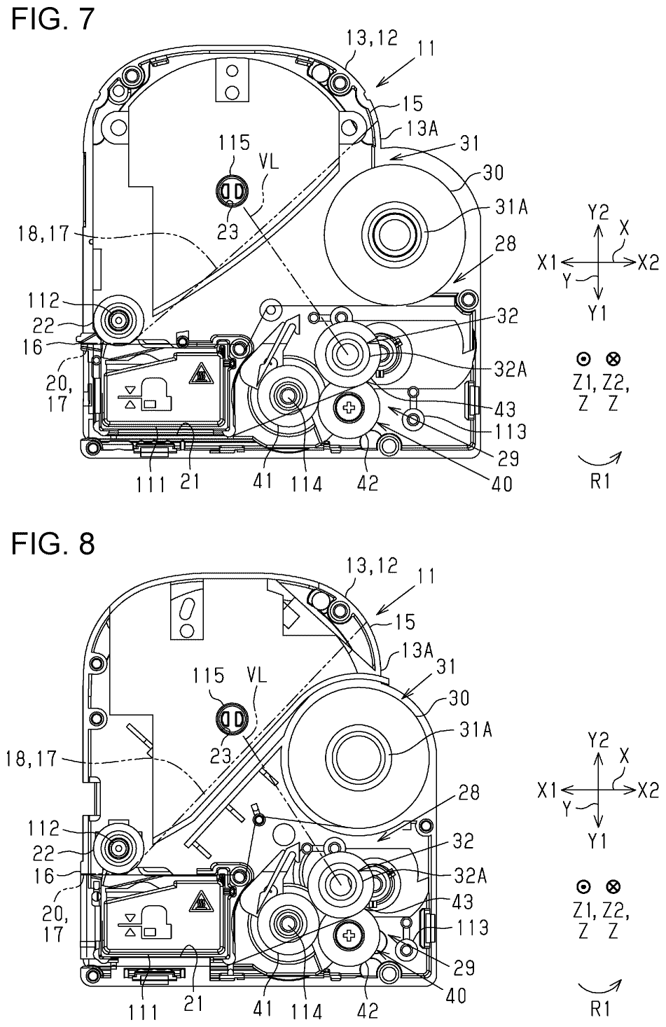

As illustrated in FIG. 7, in the second embodiment, the pay-out core 31A and the take-up core 32A may be arranged at any position. The pay-out core 31A may be provided farther in the second widthwise direction X2 than is the take-up core 32A.

Instead of the first transport path 18 and the second transport path 19, the medium transport path 17 may include a first transport path 18 that is obliquely inclined with respect to the first widthwise direction X1 and the front side Y1. The first transport path 18 may be connected to the discharge path 20. The first transport path 18 may be provided on the front side Y1 of the insertion hole 23 instead of the rear side Y2 of the insertion hole 23.

In such a case, when the ink ribbon cartridge 11 is mounted on the cartridge mounting portion 107, the pay-out roll 31 is disposed in an area on the opposite side from the platen roller 22 with respect to a virtual straight line VL in a top view. The virtual straight line VL intersects the medium transport path 17. The virtual straight line VL is a straight line connecting the center of the insertion hole 23 and the center of the rotation axis of the take-up roll 32.

### Operation and Effects of Second Embodiment

The operation and effects of the second embodiment will be described.
(9) When the ink ribbon cartridge 11 is mounted on the cartridge mounting portion 107, the pay-out roll 31 is disposed in an area on the opposite side from the platen roller 22 with respect to the virtual straight line VL in a top view. With this configuration, the ink ribbon accommodating area 28 can be provided such that the pay-out roll 31 does not interfere with the protruding portion 115 inserted into the insertion hole 23 or the platen roller 22. Therefore, it is possible to increase the amount of the ink ribbon 30 accommodated in the cartridge case 12 while reducing the size of the outer shape of the cartridge case 12. In addition, the ink ribbon cartridge 11 and a tape cartridge can be selectively mounted on the printing apparatus 100.

### Third Embodiment

Next, a third embodiment will be described.

As illustrated in FIG. 8, the third embodiment may be configured such that the pay-out roll 31 does not largely protrude from the sidewall 13A of the first case 13 as compared with the second embodiment. The third embodiment is the same as the second embodiment in that the pay-out roll 31 is disposed in an area on the opposite side from the platen roller 22 with respect to the virtual straight line VL in a top view. Therefore, it is possible to increase the amount of the ink ribbon 30 accommodated in the cartridge case 12 while reducing the size of the outer shape of the cartridge case 12.

### Modifications

The present embodiment can be modified and implemented as follows. The present embodiment and the following modifications can be implemented in combination with each other unless there is a technical contradiction.
The second case 14 may be configured so as not to protrude outward from the sidewall 13A of the first case 13 in a top view. The ink ribbon accommodating area 28 may be an area that does not protrude outward from the sidewall 13A of the first case 13 in a top view.
The ink ribbon accommodating area 28 may be provided across the first case 13 and the second case 14 as long as the take-up roll 32 is disposed at a position where the take-up roll 32 does not interfere with the gear train 40 along the Z-axis. The gear train accommodating area 29 may be provided across the first case 13 and the second case 14 as long as the gear train 40 is disposed at a position where the gear train 40 does not interfere with the take-up roll 32 along the Z-axis.
The ink ribbon accommodating area 28 may be provided at a position where the pay-out roll 31 is not surrounded by the medium transport path 17 as long as the ink ribbon accommodating area 28 does not interfere with the medium transport path 17.
In the gear train 40, the ratio between the rotation speed of the take-up shaft 114 and the rotation speed of the take-up roll 32 need not be 1:1. That is, the gear train 40 may be configured such that the rotation speed of the take-up roll 32 is slower than the rotation speed of the take-up shaft 114. The gear train 40 may be configured such that the rotational speed of the take-up roll 32 is faster than the rotational speed of the take-up shaft 114.
The gear train 40 may rotate the take-up shaft 114 and the take-up roll 32 in the same direction which is opposite to the first circumferential direction R1. In the gear train 40, the rotation direction of the take-up shaft 114 need not be the same as the rotation direction of the take-up roll 32.
The gear train 40 may include two or four or more gears. The gear train 40 may include an odd number of gears so that the rotation direction of the take-up shaft 114 is the same as the rotation direction of the take-up roll 32. The plurality of gears included in the gear train 40 may include gears whose rotation axes are not parallel to each other.
Before the ink ribbon cartridge 11 is mounted on the printing apparatus 100, the print medium may be introduced from the outside of the ink ribbon cartridge 11 to the inside of the ink ribbon cartridge 11 through the introduction port 15 and may be drawn into the first transport path 18 and the second transport path 19. In this case, the ink ribbon cartridge 11 is mounted on the printing apparatus 100 in a state in which the print medium has been drawn into the first transport path 18 and the second transport path 19.
After the ink ribbon cartridge 11 is mounted on the printing apparatus 100, the print medium may be introduced from the outside of the ink ribbon cartridge 11 to the inside of the ink ribbon cartridge 11 through the introduction port 15 and may be drawn into the first transport path 18 and the second transport path 19. In this case, the print medium may be drawn into the second transport path 19 against the restriction in the restriction direction by the restricting portion 50.
The medium transport path 17 may include another path in addition to the first transport path 18, the second transport path 19, and the discharge path 20. The medium transport path 17 need not be a path in which the first transport path 18 and the second transport path 19 intersect.
The cartridge case 12 need not be provided with the insertion hole 23. The cartridge case 12 need not include the first pay-out shaft insertion hole 26. The cartridge case 12 need not include the second pay-out shaft insertion hole 27.
The printing apparatus 100 may include the platen roller 22 itself. The ink ribbon cartridge 11 need not include the platen roller 22 and may include a platen roller insertion hole. The platen roller insertion hole is a hole into which the platen roller 22 can be inserted. When the ink ribbon cartridge 11 is mounted on the cartridge mounting portion 107, the platen roller 22 is inserted into the platen roller insertion hole.
The ink ribbon cartridge 11 may print on another print medium such as a tape instead of the tubular print medium. The ink ribbon cartridge 11 may accommodate a print medium separately from the ink ribbon 30.
The expression “at least one” used in the present specification means one or more of desired options. As an example, when the number of options is two, the expression “at least one” used in the present specification means only one option or both of the two options. As another example, when the number of options is three or more, the expression “at least one” used in the present specification means only one option or a combination of any two or more options.

### Appendix

Hereinafter, technical ideas and operational effects understood from the above-described embodiments and modifications will be described. These technical ideas and operational effects can be combined with each other within a technically consistent range.
1. An ink ribbon cartridge to be mounted on a printing apparatus having a take-up shaft for taking up an ink ribbon, the ink ribbon cartridge including a cartridge case accommodating the ink ribbon and a gear train accommodated in the cartridge case, wherein in a state where the ink ribbon cartridge is mounted on the printing apparatus, a rotation axis of a take-up roll on which the ink ribbon is taken up is different from a rotation axis of the take-up shaft, and wherein the gear train is configured to transmit power of the take-up shaft to the take-up roll.

With this configuration, since the power of the take-up shaft is transmitted to the take-up roll by the gear train, the rotation axis of the take-up roll can be made different from the rotation axis of the take-up shaft. As a result, it is possible to adjust the arrangement of the area that accommodates the take-up roll inside the cartridge case. Therefore, the amount of the ink ribbon accommodated in the cartridge case can be increased.
2. The ink ribbon cartridge, wherein the cartridge case may include a first case and a second case located farther in a direction opposite to a first axial direction along the rotation axis of the take-up roll than is the first case, wherein the first case may include a gear train accommodating area accommodating the gear train, and wherein the second case may include an introduction port through which a print medium is introduced into the cartridge case, a medium transport path along which the print medium is transported, and an ink ribbon accommodating area accommodating a pay-out roll from which the ink ribbon is fed and the take-up roll.

With this configuration, it is possible to provide the gear train accommodating area which accommodates the gear train in the first case, and to provide the introduction port, the medium transport path, and the ink ribbon accommodating area which accommodates the pay-out roll and the take-up roll in the second case. As a result, it is possible to provide the gear train accommodating area in the first case so as not to interfere with the introduction port, the medium transport path, or the ink ribbon accommodating area in the second case. Therefore, the amount of the ink ribbon accommodated in the cartridge case can be increased.
3. The ink ribbon cartridge, wherein the gear train may include a first gear coaxial with the take-up shaft when viewed in the first axial direction, a third gear having a rotation axis which is the same as the rotation axis of the take-up roll when viewed in the first axial direction, and a second gear configured to transmit power of the first gear to the third gear, and wherein the rotation axis of the third gear may be separated from a rotation axis of the pay-out roll by a predetermined distance.

With this configuration, the power of the take-up shaft can be transmitted to the take-up roll by using the first gear, the second gear, and the third gear. In addition, the rotation axis of the take-up roll, which is coaxial with the third gear, can be separated from the rotation axis of the pay-out roll by a predetermined distance. As a result, it is possible to accommodate an amount of the ink ribbon in consideration of the predetermined distance. Therefore, the amount of the ink ribbon accommodated in the cartridge case can be increased.
4. The ink ribbon cartridge, wherein the gear train may rotate the take-up roll in a first circumferential direction when the take-up shaft rotates in the first circumferential direction.

With this configuration, it is possible to rotate the take-up shaft and the take-up roll in the same first circumferential direction. As a result, it is possible to suppress a decrease in printing quality. In addition, the configuration of the printing apparatus need not be changed.
5. The ink ribbon cartridge, wherein the gear train may be configured such that a ratio between a rotation speed of the take-up shaft and a rotation speed of the take-up roll is 1:1.

With this configuration, the rotation speed of the take-up shaft and the rotation speed of the take-up roll can be set to the same ratio. As a result, it is possible to suppress a decrease in printing quality. In addition, the configuration of the printing apparatus need not be changed.
6. The ink ribbon cartridge, wherein the medium transport path may include a first transport path extending from the introduction port in a first direction intersecting the first axial direction, and a second transport path connected to the first transport path and extending in a second direction intersecting the first axial direction and the first direction, and wherein when viewed in the first axial direction, the pay-out roll may be disposed in an area surrounded by the first transport path, the second transport path, and the gear train accommodating area in the ink ribbon accommodating area.

With this configuration, it is possible to provide the ink ribbon accommodating area such that the pay-out roll does not interfere with the first transport path, the second transport path, or the gear train accommodating area. Therefore, the amount of the ink ribbon accommodated in the cartridge case can be increased.
7. The ink ribbon cartridge, wherein when the ink ribbon cartridge and a tape cartridge accommodating a print tape roll are selectively mountable on a cartridge mounting portion of the printing apparatus, and when a protruding portion provided on the cartridge mounting portion is configured to be inserted into a rotation center of the print tape roll when the tape cartridge is mounted on the cartridge mounting portion, the cartridge case may be provided with an insertion hole into which the protruding portion is inserted when the ink ribbon cartridge is mounted on the cartridge mounting portion, and wherein when the ink ribbon cartridge is mounted on the cartridge mounting portion, the pay-out roll may be disposed in an area between the insertion hole and the gear train accommodating area when viewed in the first axial direction.

With this configuration, when viewed in the first axial direction, the pay-out roll is disposed in an area between the insertion hole into which the protruding portion is inserted and the gear train accommodating area. As a result, it is possible to provide the ink ribbon accommodating area such that the pay-out roll does not interfere with the protruding portion inserted into the insertion hole or the gear train accommodating area.

Therefore, the amount of the ink ribbon accommodated in the cartridge case can be increased. In addition, the ink ribbon cartridge and the tape cartridge can be selectively mounted on the printing apparatus.
8. The ink ribbon cartridge, wherein the second case may be configured to protrude outward from a sidewall of the first case when viewed in the first axial direction, and wherein the ink ribbon accommodating area may include an area protruding outward from the sidewall of the first case when viewed in the first axial direction.

With this configuration, the second case in which the ink ribbon accommodating area is provided can be provided so as to protrude outward from the sidewall of the first case in which the gear train accommodating area is provided. Therefore, it is possible to increase the amount of the ink ribbon accommodated in the cartridge case while suppressing an increase in the size of the first case.
9. The ink ribbon cartridge may further include a platen roller, wherein when the ink ribbon cartridge and a tape cartridge accommodating a print tape roll are selectively mountable on a cartridge mounting portion of the printing apparatus, and when a protruding portion provided on the cartridge mounting portion is configured to be inserted into a rotation center of the print tape roll when the tape cartridge is mounted on the cartridge mounting portion, the cartridge case may be provided with an insertion hole into which the protruding portion is inserted when the ink ribbon cartridge is mounted on the cartridge mounting portion, and wherein when the ink ribbon cartridge is mounted on the cartridge mounting portion, the pay-out roll may be disposed in an area on an opposite side from the platen roller with respect to a virtual straight line intersecting the medium transport path and connecting a center of the insertion hole and a center of the rotation axis of the take-up roll, when viewed in the first axial direction.

With this configuration, when viewed in the first axial direction, the pay-out roll is disposed in an area on the opposite side from the platen roller with respect to the virtual straight line intersecting the medium transport path and connecting the center of the insertion hole and the center of the rotation axis of the take-up roll. As a result, it is possible to provide the ink ribbon accommodating area such that the pay-out roll does not interfere with the protruding portion inserted into the insertion hole or the platen roller. Therefore, it is possible to increase the amount of the ink ribbon accommodated in the cartridge case while reducing the size of the outer shape of the cartridge case. In addition, the ink ribbon cartridge and the tape cartridge can be selectively mounted on the printing apparatus.

What is claimed is:

1. An ink ribbon cartridge to be mounted on a printing apparatus having a take-up shaft for taking up an ink ribbon, the ink ribbon cartridge comprising:
a cartridge case accommodating the ink ribbon; and
a gear train accommodated in the cartridge case,
wherein in a state where the ink ribbon cartridge is mounted on the printing apparatus, a rotation axis of a take-up roll on which the ink ribbon is taken up is different from a rotation axis of the take-up shaft, and
wherein the gear train is configured to transmit power of the take-up shaft to the take-up roll.

2. The ink ribbon cartridge according to claim 1,
wherein the cartridge case includes:
a first case; and
a second case located farther in a direction opposite to a first axial direction along the rotation axis of the take-up roll than is the first case,
wherein the first case includes a gear train accommodating area accommodating the gear train, and
wherein the second case includes:
an introduction port through which a print medium is introduced into the cartridge case;
a medium transport path along which the print medium is transported; and
an ink ribbon accommodating area accommodating a pay-out roll from which the ink ribbon is fed and the take-up roll.

3. The ink ribbon cartridge according to claim 2,
wherein the gear train includes:
a first gear coaxial with the take-up shaft when viewed in the first axial direction;
a third gear having a rotation axis which is the same as the rotation axis of the take-up roll when viewed in the first axial direction; and
a second gear configured to transmit power of the first gear to the third gear, and
wherein the rotation axis of the third gear is separated from a rotation axis of the pay-out roll by a predetermined distance.

4. The ink ribbon cartridge according to claim 1,
wherein the gear train rotates the take-up roll in a first circumferential direction when the take-up shaft rotates in the first circumferential direction.

5. The ink ribbon cartridge according to claim 4, wherein,
the gear train is configured such that a ratio between a rotation speed of the take-up shaft and a rotation speed of the take-up roll is 1:1.

6. The ink ribbon cartridge according to claim 2,
wherein the medium transport path includes:
a first transport path extending from the introduction port in a first direction intersecting the first axial direction; and
a second transport path connected to the first transport path and extending in a second direction intersecting the first axial direction and the first direction, and
wherein when viewed in the first axial direction, the pay-out roll is disposed in an area surrounded by the first transport path, the second transport path, and the gear train accommodating area in the ink ribbon accommodating area.

7. The ink ribbon cartridge according to claim 2,
wherein when the ink ribbon cartridge and a tape cartridge accommodating a print tape roll are selectively mountable on a cartridge mounting portion of the printing apparatus, and when a protruding portion provided on the cartridge mounting portion is configured to be inserted into a rotation center of the print tape roll when the tape cartridge is mounted on the cartridge mounting portion,
the cartridge case is provided with an insertion hole into which the protruding portion is inserted when the ink ribbon cartridge is mounted on the cartridge mounting portion, and
wherein when the ink ribbon cartridge is mounted on the cartridge mounting portion, the pay-out roll is disposed in an area between the insertion hole and the gear train accommodating area when viewed in the first axial direction.

8. The ink ribbon cartridge according to claim 2,
wherein the second case is configured to protrude outward from a sidewall of the first case when viewed in the first axial direction, and
wherein the ink ribbon accommodating area includes an area protruding outward from the sidewall of the first case when viewed in the first axial direction.

9. The ink ribbon cartridge according to claim 2, further comprising:
a platen roller,
wherein when the ink ribbon cartridge and a tape cartridge accommodating a print tape roll are selectively mountable on a cartridge mounting portion of the printing apparatus, and when a protruding portion provided on the cartridge mounting portion is configured to be inserted into a rotation center of the print tape roll when the tape cartridge is mounted on the cartridge mounting portion,
the cartridge case is provided with an insertion hole into which the protruding portion is inserted when the ink ribbon cartridge is mounted on the cartridge mounting portion, and
wherein when the ink ribbon cartridge is mounted on the cartridge mounting portion, the pay-out roll is disposed in an area on an opposite side from the platen roller with respect to a virtual straight line intersecting the medium transport path and connecting a center of the insertion hole and a center of the rotation axis of the take-up roll, when viewed in the first axial direction.
